(19) United States
(12) Patent Application Publication
(10) Pub. No.: US 2021/0044177 A1
(43) Pub. Date: Feb. 11, 2021

(54) ELECTRIC GENERATOR DEVICE

(71) Applicant: Mubarak Manahi ALGHAMEDI, Mashoga (SA)

(72) Inventor: Mubarak Manahi ALGHAMEDI, Mashoga (SA)

(21) Appl. No.: 16/978,738

(22) PCT Filed: Feb. 25, 2019
(86) PCT No.: PCT/SA2019/000003

§ 371 Date: Sep. 7, 2020

(30) Foreign Application Priority Data
Mar. 20, 2018 (GC) GC2018-34994

(51) Int. Cl. H02K 7/18; F03G 3/06; F03G 3/08; B25J 9/12

(52) U.S. Cl. CPC H02K 7/1853; F03G 3/06; F03G 7/10; B25J 9/12; F03G 3/08

(57) ABSTRACT

This invention is a mechanic machine that works by gravity using vibration. It consists of a hanged Pendulum in the middle, above which two gears are fixed which are the movement generator for all gears in both sides in order to generate clean, consistent and free power. In bottom of Pendulum, attached a dissonant magnet and in bottom of machine there is another dissonant magnet to secure consistent movement of Pendulum continuously, in addition to two iron curved brackets, each is almost quarter circle carrying all parts of this invention, vibrating with Pendulum movement whose bottom is heavier than its head, in addition to some diversified gears and mechanical fixations to increase speed, multiplate movement and control movement in single direction. This machine could be minimized and maximized as needed, and we can replace magnet with a small hydraulic piston in a side. There are 2 dynamos for power generation in both sides. Robot can be employed to operate this machine. Refer to FIG. 2

### SUMMARY

It is a cost-free and environmentally friendly electricity generator machine working by gravity by the action of wobble and vibration. It is very similar to a Trojan horse swaying back and forth permanently and continuously. It has various sizes. This machine is placed directly on a solid and flat floor or on its own base and consists of two iron chassis arcs open from the top with a polished back and like the two arches in a Trojan horse, and both of them is like the mallow cutter or the crescent, and these two curved arcs open from the top are approximately a quarter of a circle each carrying all the components of this Invention and all the part that continuously swing above them. There is also a steel pendulum hanged in the middle between two iron walls in the center of the machine from the inside. At the bottom of the pendulum, a large repulsive magnet is installed with another separate magnet installed below the machine between the two iron walls. It is a natural or permanent magnet or works with electricity when passing over each other directly to continue Movement of the pendulum and lack of stillness. This pendulum does not reach the ground and the bottom is heavier than the top due to the heavy weight and it is the engine of all gears in continuous interaction with the movement of the arcs so that the machine is in constant motion, without external interference and this the main idea , genius, uniqueness of this innovation. There is on both sides of the two steel walls from outside two gears installed in pendulum top from both sides by rolling Bearings at the top of walls from the outside, under each of them in both directions there are multiple gears of different sizes, less and less, installed in the two walls by rolling bearings, the bottom of which there are two very small gears with two long crankshaft connecting horizontal poles , at the bottom of which there are mechanical equipment to direct the reciprocating movement into a movement in one direction, as a Free roll which exchanges movement and torque between the two sides of the machine with a large rolling bearings attached above the arc fixed in each of them on the outside of the machine a middle-size wheel and behind it is a large solid rotating wheel for permanent torque and the continuation of the pace of movement traveling in one direction connected to a belt from its base in the middle wheel from the inside with electricity generating dynamo . Refer to FIG. 2

### TECHNICAL FIELD

The present disclosure is directed to devices and methods for Electric generation. More specifically, the present disclosure is directed to devices, and methods for electric generation based on gravity with using repulsive magnets.

### BACKGROUND OF THE DISCLOSURE

It has been well established that an energy crisis exists in the world at present. The demand for energy, and particularly electrical energy has increased materially and continues to increase. Supplies of fossil fuel are dwindling and cannot be depended upon to supply all energy requirements. Although atomic energy has offered a partial solution to the energy crisis its environmental problems have delayed its development. Even with the availability of sufficient fossil fuels, the pollution caused by such fuels is still a serious problem. A great deal of effort is being expended by environmentalist to prevent the construction of additional generating facilities which would add to water, air and thermal pollution. The availability of forces in nature as a possible source of energy has been recognized. The use of wind, waves, and sun as energy sources has been considered.

Solar power generation has many methods, many of which are now common solar power, but have defects and disadvantages that they work only in the day under a strong sun and stop during the clouds, fog and dust. The cost of producing panels is expensive and the most expensive in solar storage and transportation. Wind energy is the least productive and its equipment is very expensive and causes noise to the people living next to it. It works only when the wind passes, so little in the summer, as well as the nuclear energy and the energy produced by the fossil fuels and the danger it poses to humans and the environment. This invention is the first of its kind in the field of energy and gives continuous clean and free energy.

The force of gravity is pretty much the same at any location on the surface of the earth, a virtual constant. On the other hand, centrifugal force is infinitely variable and can be generated as a periodic or cyclic action.

The principle of the conservation of energy was established and disseminated to the scientific community by Hermann Helmholtz in a series of lectures delivered in Germany in 1862-1863. Although Helmholtz and others since him have considered numerous instances of force, work, energy, and motion in heat, mechanics, magnetism, electricity, and chemicals, they apparently have not explored the ramifications of centrifugal force. Specifically, that centripetal and centrifugal are equal and opposite but do not operate on the same body and thus do not cancel each other. And that doubling the speed of rotation returns FOUR times the force.

Almost any physics textbook in use since the nineteenth century tries to convey the impossibility of the creation of energy. The principle of conservation of energy has never been conclusively proven, just assumed because not unproven, until now.

Newton's laws happen to be in agreement with nature to a certain extent. They are not all inclusive, however, as demonstrated by Einstein

Newton's First Law of Motion: A particle not subjected to external forces remains at rest or moves with constant speed in a straight line. For Angular Motion: A body not acted upon by a torque continues in its state of rest or if spinning continues to spin with constant angular momentum.

Flywheels are sometimes used to store kinetic energy for later use. For instance, torque is applied by an electric motor and kinetic energy is stored in the flywheel. Disregarding friction, the flywheel would, in theory, spin forever. The same electric motor used to spin the flywheel can also be used as a generator to later extract the kinetic energy from the flywheel with an efficiency exceeding 95%.

Newton's Second Law of Motion: The acceleration of a particle is directly proportional to the resultant external force acting on the particle and is inversely proportional to the mass of the particle. For Angular Motion: The rate of change of angular momentum equals the applied torque.

However, centripetal acceleration is measured at a right angle, or perpendicular to angular momentum and any applied or extracted torque.

Newton's Third Law of Motion: If two particles interact, the force exerted by the first particle on the second particle (called the action force) is equal in magnitude and opposite in direction to the force exerted by the second particle on the first particle (called the reaction force). For Angular Motion: Corresponding to a torque applied to one body (action) there is always an equal, opposite torque on another (reaction). These three laws describe and allow for the measurement of kinetic energy and angular momentum, but centrifugal force is not equal and opposite to kinetic energy, centrifugal force is a by-product generated at right angles to rotational kinetic energy and angular momentum. Flywheel design engineers know that if certain rotational speeds are exceeded, the flywheel will literally explode due to the tremendous centrifugal forces generated. A car going too fast around a corner can literally be forced off the road and caused to roll over several times due to centrifugal force. Centripetal and centrifugal forces have been perceived as something hazardous to be avoided or dealt with for the most part, but sometimes used for good as in a centrifuge to separate materials, or by NASA to create artificial G-forces.

Using the momentum of a pendulum as a way of producing work has been known for centuries. What has changed is the means for maintaining the pendulum swing as well as the means to convert a substantially linear movement into a movement more readily adaptable for producing useful work.

The prior art discloses an apparatus for harnessing the energy derived from the undulatory motion of a body of water including: a pendulum assembly having a buoyancy sufficient for maintaining it afloat in the water, a first structure substantially following multidirectional undulatory motions of the water and second structure mounted in the assembly for free movement in a plurality of planes with respect to the first structure. The second structure is displaceable by gravity and by forces derived from the movement of the first structure. There is further provided in the prior art a device connected to the first and second structures for generating a pressure output in response to the force derived from the relative motions between the first and second structures. An arrangement is coupled to the pressure output of the device for utilizing, at least indirectly, the energy derived from the pressure output.

The prior art also discloses an energy generator including a pendulum suspended at one end and in operative relationship with an external power device which imparts oscillation movements to the pendulum. The pendulum includes a weight disposed at one end and in operative cooperation with a hydraulic fluid cylinder to increase the hydraulic pressure of the fluid within the cylinder. A power output device receives the high pressure hydraulic fluid and generates output power. A second embodiment is directed to a power booster wherein energy is transferred between a pendulum and a power generating device.

Also, the prior art discloses a prime mover that stores mechanical energy in case of an electrical failure. When an electrical failure occurs, the prime mover is activated either manually or automatically by a computer with a battery back-up. The prime mover oscillates back and forth in a pendulum-like fashion which in turn drives an electrical generator in order to produce electricity. The prime mover comprises a base, elements that are rotatably mounted to the base, a pick-up balance that is rotatably mounted to the base and a drive that operatively connects the prime mover to the electrical generator.

The invention patent CN87106130 discloses a vibration energy conversion means on the transport vehicle damping spring is coupled to the frame or have additional Vehicle shaft rod and a spherical bowl-shaped section bar section, with respect to the frame using a shaft Vehicle vibration energy into electrical energy transportation vehicle power, fluid pressure energy, the gas pressure energy, the energy transport means which replaces the existing vehicle fuel or electricity powered. This is achieved by means of an elastic potential energy by a spring rod and a spherical bowl-shaped section bar section is converted into other forms of energy.

The invention patent CN200810031082. 0 discloses an engine comprising a green energy generation system and an engine system, the green energy generating system is connected through a pipe of the engine system, the green energy generating system includes an inertial mass, spring resonance, the pump or air compressor. The vibration energy of the engine according to the present invention is to produce mechanical movement, the object of conversion is converted into an oil pump driving a hydraulic energy into the pressure energy or drive the air compressor, the driving of the engine to achieve, but does not address the fluctuation in the object energy conversion problems.

Patent invention CN201010165824 6 discloses a gravity generator which comprises a power means connected to the generator, the power mechanism includes a chain sprocket by the chain mechanism is placed upright with its two sprockets a plurality of weight members disposed on. Left and right side of the centerline is divided into two sprockets fall section with the riser, falling section of the weight member to the chain section than the rising arm member to the weight arm length of the chain. With a turn drive generator.

The invention patent CN200680002157. 1 discloses a gravity gear or gravity highway on power generation is a high gravitational a low, from a high slope to a low wave, and then from the low slope forward transition to another high slope a, followed by the high slope from the low slope, repeated continuously extending to the level of such a circular track or a gravitational attraction power on a straight track.

Currently, the known gravitational energy development facilities, system complexity, high cost, low efficiency, difficult to large-scale commercial operation.

### SUMMARY OF THE DISCLOSURE

The present invention provides apparatus for harnessing such preexisting forces to supply electrical energy. The generating devices of the present invention can effectively aid in supplying the additional electrical requirements in conjunction with present facilities. The generating devices of the present invention may be used as residential generators to permit a home owner to reduce the amount of electricity he must buy and may also be constructed in large sizes to provide additional generating capability for larger installations and may even be used as generating stations by power companies.

Several objects and advantages of the present invention are to:

(a) provide excess usable electricity utilizing a non-polluting renewable source of energy;

(b) reduce pollution on planet Earth;

(c) reduce global warming;

(d) reduce coal mining and destruction of the land;

(e) reduce dependence on foreign oil;

(f) reduce the need for dangerous nuclear power plants;

(g) decrease the cost of energy for the consumer.

Still further objects and advantages will become apparent from a consideration of the ensuing description and drawings.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a diagram of an apparatus shown as an exemplary Electric generator according to one or more aspects of the present disclosure;

Shows a front view of the details of the present invention device
1—Top of the hanging pendulum in the middle of the device
2—The place of fixing the pendulum between the two upper large iron gears, and connected to install bearings between the middle iron walls in the middle and top of the device
3—the large upper iron gear
4—one of the iron walls in the middle
5—End of the drive shaft fixed horizontally by bearings from the two ends of the suspended pendulum and the two large gears connected to it
6—Iron fastening connection between the iron middle wall and the outer iron wall
7—The motion control mechanism in one mechanic direction attached to it a speeding device and a motion multiplier all are installed by bearings in the middle iron wall and connected to the first small gear under the large gear
8—drive and transmission shaft
9—bearings
10—Medium gear
11—Rotation connection
12—bearings installed in the outer iron wall
13—Iron base welded in the middle iron wall to fix the outer large gear only
14—installation and drive shaft of the large gear is installed in the welded base only and not directly connected to the iron wall
15—A small connecting gear between the two middle gears installed in the outer iron wall by bearings, It is the engine of the very large external gear and is also installed to fixing, rotation shaft and bearings to the middle iron wall
16—large bearings installed in the outer iron wall equipped with a free rotator in one mechanical direction and the outer large gear is installed to it and connected to the drive shaft fixed on the welded base in the middle iron wall.
   17—Very large outer gear
   18—The mechanical motion control device is attached with a speeding device and a motion multiplier, all fixed in the middle iron wall and connected to the third small gear under the large gear.
   19—drive and transmission shaft
   20—bearings
   21. middle gear
   22—Rotation connection
   23—bearings installed in the outer iron wall
   24—The third small gear under the large gear between the two middle iron walls and between the first gear which is a gear of the same size and installed all in the middle wall by bearings
   25—A very small gear is fixed to the bearings under the third small gear between the middle wall
   26—The fixed dynamo by bearings and connected to the very small gear, in order to calculate and measure the movement of the device and help control and operate the device
   27—area below the hanging pendulum, which is widened and heavier than the top one which is the position of the torque and involves iron weights or concrete cube to increase the strength and movement
   28—The first repelled magnet attached to the bottom of the pendulum
   29—The second repelled magnet fixed with the drive shaft between the iron middle walls at the bottom and middle of the device
   30—a moving shaft installed for the second repelled magnet in the middle iron wall by bearings in opposite to a second shaft in the other middle wall installed by bearings to help the magnet to sway and simple movement to push the pendulum in the other direction constantly
   31—Electric generation Dynamo
   32—Very small gear is installed on the edge of the very large outer gear to drive the Electric generation Dynamo
   33—iron installation connection between the two outer iron walls and the two middle iron walls above the curved arcades carrying all the details of this device

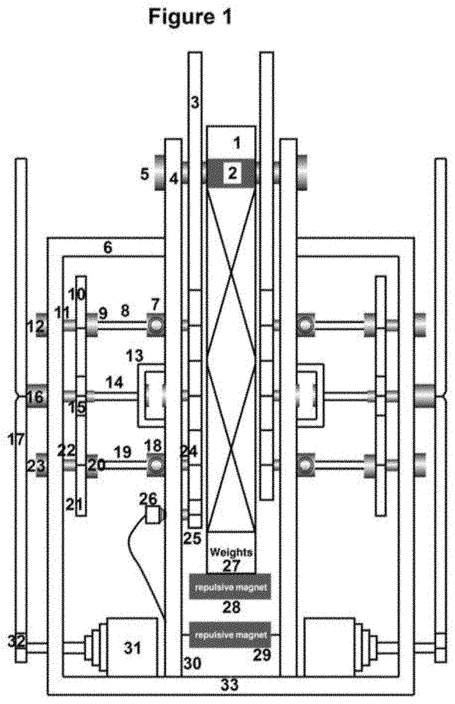

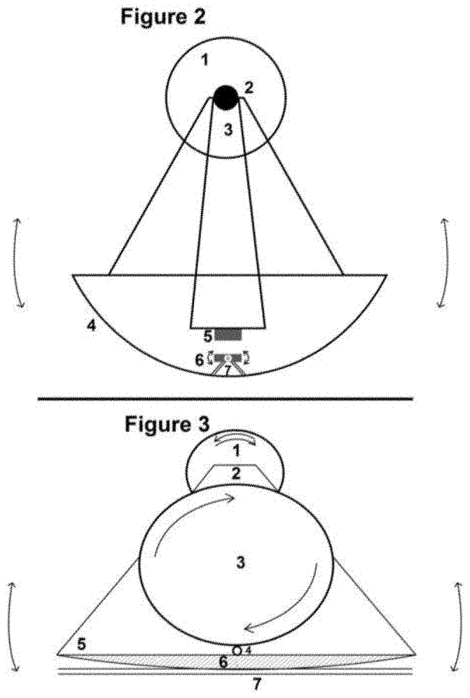

FIG. 2 is an enlarged view of an exemplary Electric generator shown in FIG. 1;

Shows a side view of the device

1—one of the large gears connected to the pendulum by bearings at the top of the device between the two middle iron walls
2—bearings to fix the two large gears at the top and the iron hanging pendulum
3—the iron hanging pendulum where its bottom is widened and heavier than above and in it the torque which drive all gears
4—one of the curved iron brackets which is constantly moving by gravity
5—the first repelled magnet attached to the bottom of the pendulum
6—The second repelled magnet between the two middle iron walls and swaying with the movement of the pendulum and works to prevent the pendulum from stopping and rest

FIG. 3 is a diagram showing the operation of the Electric generator shown in FIG. 1.

Shows another side view of the device
1—one of the large gears in the middle of the device and moves with the movement of the pendulum in an oscillatory movement
2—The upper part of one of the iron middle walls of the two sides
3—The gear is very large and moves outward in one direction, durable, continuous and high speed due to the speed double movement, mechanical and motion control in one direction devices
4—a very small gear is installed on the edge of the very large outer gear and drives the electric generation dynamo
5. One of the external iron walls
6—One of the iron arches
7—iron threaded belts installed in the ground holder of the device with the placement of teeth as well behind the iron curved brackets holding the device to interlock with the teeth of belts and the placement of these belts optional when necessary to prevent the device from slipping away from its original position in extreme wind and hurricane areas.

### DETAILED DESCRIPTION

In the following detailed description, reference is made to the accompanying drawings, which form a part hereof, and in which is shown by way of illustration embodiments in which the inventions may be practiced. These embodiments are described in sufficient detail to enable those skilled in the art to practice the invention, and it is to be understood that other embodiments may be utilized and mechanical changes may be made without departing from the spirit and scope of the present invention. The following detailed description is, therefore, not to be taken in a limiting sense, and the scope of the present invention is defined only by the claims and equivalents thereof.

Embodiments of the present invention provide for an electric generator device and components thereof.

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

FIG. 1, the electric generator device according to the present invention, the device comprises a Pendulum hanging between bearings at the top of the device in the middle and in the T-shaped iron bar. Pendulum is installed between the walls at the center, the top and on the sides and is installed by two large arches of the two engines of the central gears attached to the metal and then the engine in turn to the rest of the gears, a large gear installed in the pendulum.

Internal iron wall. The end of the bearings, hanging on one side of the pendulum and the threaded gear. Bearings in the device of speed and mechanical movement. A connecting beam between the bearings and the speed and movement device and the one-way motion control device. Mechanical control the movement in one direction with bearings. Middle threaded iron gear. Installation beam in the outer iron wall.

The end of the bearings in the outer iron wall. Welded installation connection in the internal iron wall. stabilization, balancing and loading beam. A connecting beam between the small gear and the outer iron wall and then the very large outer iron gear. Bearings for the external iron gear installation is very large. The large threaded electric gear of the dynamo generating electricity on its end can be replaced by a generator of direct electricity and the movement of this gear is free in one direction due to the automatic motion direction control devices, which resembles the movement of the bicycle wheel. A device for speed and movement and installed by bearings. Circular beam connecting the movement multiplier and the speed and one-way mechanical control.

Motion control with bearings. Threaded middle gear. A connecting beam between the gear and the outer iron wall. The end of the bearings in the outer iron wall. Middle internal iron gear. Very small gear operates the piston mechanically in alternating manner Sensor and measurement of movement linked to the computer or robot. The bottom of the suspended pendulum with its weights and may be batteries or electric regulator or concrete cube and this is the torque and driving force of the gears, which produce a lot of electricity.

Magnet plates with a suspended pendulum sticker at the bottom. Magnet plates mounted on the ground base of the device and swaying according to the movement of the pendulum and between it and the other magnet enough distance to allow movement and does not stop the pendulum in one direction and swaying to push the pendulum to the other side. The iron base in the shape of a triangle bearing the magnet below and with bolts installed to allow it to sway with the movement of suspended pendulum. Dynamo is an energy generator similar to the dynamo in wind power fans. Two or more generators can be installed on the very large outer gear edge depending on the torque in the pendulum. Very small gear which moving the dynamo motor is installed under the very large iron-out gear. Ground loading iron beams installed above it the iron arches and the details of this invention.

FIG. 2 shows another view of the device include the side of the large iron gears installed on top of the pendulum. Installation bearings for the upper gears including suspended pendulum. Suspended iron pendulum. The curved arc is quarter of a circle. Magnet installed at the bottom of the pendulum. Magnet installed at the bottom between the two center walls near the surface of the earth. base of loading the lower magnet and show the method of twisting the right and left with the passage of suspended pendulum movement.

FIG. 3 shows operational view of the device include large gear fixed at the top of the pendulum and moving in opposite directions according to the movement of the pendulum. The internal iron wall. The external gear is very large and moves in one direction due to the mechanical direction control devices. A very small gear is installed under the very large external gear which is the engine of dynamo generation. The outer iron wall. The curved iron arch is quarter of a circle. the iron floor on which this device is installed.

The terms “a,” “an,” and “the” include plural referents unless the context clearly dictates otherwise. For example, “a piston” is understood to represent one or more pistons. The terms “a” (or “an”), as well as the terms “one or more,” and “at least one” can be used interchangeably herein. Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

### LIST OF COMPONENTS

1 pendulum
2 Large gear
3 internal iron wall
4 end of bearings
5 external iron wall
6 bearings with speed providing device
7 connecting rod between bearings and speed providing device
8 mechanical control device of the motion direction
9 threaded middle iron gear
10 installation beam
11 welded joint in the internal iron wall
12 installations and balancing beam
13 connecting rod between pinion and internal iron wall
14 speed providing device
15 circular rod connecting doubling device and speed provider
16 control device
17 motion measurement pinion
18 sensor
19 repulsive magnet plates
20 iron base
21 dynamo
22 dynamo moving pinion
23 iron beams
24 quarter circular Arche
25 pistons

1. An Electric generator comprising:
a means of rotating,
a pendulum and two arcs with a quarter-circle size for each, to create the energy of the centrifugal forces, and means of extracting to capture the said energy, and means of conversion to change the said energy into usable forms.

2. The generator of claim 1, as two of the curved arcs are open up with a size of a quarter of a circle for each of them on which all the details and parts of the invention are to be fixed.

3. The generator of claim 1 wherein the pendulum is a hanging pendulum that does not reach the ground in the center of the machine is characterized by the fact that its bottom is heavier than above.

4. The generator of claim 1 wherein the pendulum is the engine for all gears on both sides of the machine in continuous interaction with the movement of the arcs.

5. The generator of claim 1 further comprising Two discrete discordant magnets.

6. The generator of claim 5 wherein, one of the magnet is placed under the pendulum and the other under the machine between the two iron walls.

7. The generator of claim 5 wherein the magnets provide permanent movement of the pendulum.

8. The generator of claim 1, as two gears are upper, between them the pendulum is fixed which drives them, and they move all the other gears.

9. The generator of claim 1, since the gradient in motion depends on the size of the gears from largest to smallest.

10. The generator of claim 1, where there are two external wheels that move in one direction due to mechanical controls and one-way multiplier devices. These two wheels are similar to the bicycle wheel in terms of free movement.

11. The generator of claim 1, where the permanent movement of the arcs and the pendulum is used in the production of electricity.

12. The generator of claim 1, where there are all details of this invention oscillate over the arcs and permanently move away from the fulcrum.

13. The generator of claim 1, where it increases the use of gravity in the production of electricity by using two repulsive magnets to obtain the maximum benefit in each movement of the pendulum to produce the electricity.

14. A Robot used to operates large machines.

15. The robot of claim 14 which measures motion by interacting with the movement of the pendulum.

16. The robot of claim 14 derives its power from the machine itself with direct electrical or by storage battery.
